(19) United States
(12) Patent Application Publication
(10) Pub. No.: US 2014/0336044 A1
(43) Pub. Date: Nov. 13, 2014

(54) Copper-Manganese Spinel Catalysts and Methods of Making Same

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CDTi, Ventura, CA (US)

(21) Appl. No.: 13/891,617

(22) Filed: May 10, 2013

(51) Int. Cl. B01J 23/889

(52) U.S. Cl. CPC B01J 23/8892
USPC 502/303; 502/304; 502/324; 502/302

(57) ABSTRACT

Disclosed here are material formulations of use in the conversion of exhaust gases, where the formulations may include Copper (Cu), Manganese (Mn) and combinations thereof. Combinations of use may include Cu—Mn Spinels. Catalysts including these materials may be synthesized by methods including co-precipitation, co-milling, templating, and the sol-gel method, using any suitable carrier material oxide and any suitable oxygen storage material. The properties of the catalysts disclosed may vary according to the calcining temperature, where stoichiometric and non-stoichiometric Cu—Mn Spinels may form when calcining suitable formulations at suitable temperatures.

### TECHNICAL FIELD

This disclosure relates generally to catalytic converters, and, more particularly, to materials of use in catalyst systems.

### BACKGROUND INFORMATION

Emissions standards seek the reduction of a variety of materials in exhaust gases, including unburned hydrocarbons (HC), carbon monoxide (CO), and nitrogen oxides (NO). In order to meet such standards, catalyst systems able to convert such materials present in the exhaust of any number of mechanisms are needed.

To this end, there is a continuing need to provide materials able to perform in a variety of environments, which may vary in a number ways, including oxygen content and the temperature of the gases undergoing treatment.

### SUMMARY

Materials suitable for use as catalyst include Copper (Cu), Manganese (Mn), Copper Oxides, Manganese Oxides, Copper Manganese Oxides, and combinations thereof.

Methods for preparing catalysts containing these materials may use copper nitrate or copper acetate and manganese nitrate or manganese acetate solutions.

Support materials of use in catalysts containing one or more of the aforementioned combinations may include Cerium Oxide, Alumina, Lanthanum doped alumina, Titanium Oxide, Zirconia, Ceria-Zirconia, Nb2O5-ZrO2, and any combination thereof.

Oxygen Storage Materials of use in catalysts containing one or more of the aforementioned combinations may include Cerium Oxide, Zirconium Oxide, Lanthanum oxide, Yttrium oxide, Lanthanide Oxides, Actinide Oxides, and any combination thereof.

Catalysts containing Copper and Manganese may include catalysts containing stoichiometric and non-stoichiometric Cu—Mn Spinel, where stoichiometric and non-stoichiometric Cu—Mn Spinel may be formed during calcining at any suitable temperature, including temperatures in the range of about 300° C.-800° C. Stoichiometric Spinels of use in TWC applications may include those formed at temperatures in the range of about 300° C.-600° C. Stoichiometric and non-stoichiometric Cu—Mn Spinel may present in form of mixed phase with either Cu oxide or Mn oxide. The Cu/Cu+Mn molar ratios and crystallite size of mix phase may be variable. Stoichiometric Cu—Mn Spinels phase has greater NO conversion compare to non-Stoichiometric Cu—Mn Spinels under rich condition.

Catalysts containing Copper and Manganese may be synthesized by any suitable method, including co-precipitation, co-milling, templating, and the sol-gel method. The resulting catalyst may be used in any suitable form, including as a powder and as component of a coat or overcoat on a substrate.

Suitable precipitant agents of use in synthesizing these catalysts may include NaOH solutions, Na2CO3 solutions, and ammonium hydroxide (NH4OH) solutions. Suitable aging times of use in the co-precipitation method may include any period of time in the range of 12-36 hours.

Numerous other aspects, features and advantages of the present disclosure may be made apparent from the following detailed description, taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the invention. In the figures, any reference numerals designate corresponding parts throughout different views.

FIG. 1 is an XRD Graph for a Type 1.A Catalyst

FIG. 2 is an XRD Graph for a Type 1.B Catalyst

FIG. 3 is an XRD Graph for a Type 1.C Catalyst

FIG. 4 is an XRD Graph for a Type 1.D Catalyst

FIG. 5 is an XRD Comparison Graph for Type 1 Catalysts

FIG. 6 is an XRD Graph for a Type 2.A Catalyst

FIG. 7 is an XRD Graph for a Type 2.B Catalyst

FIG. 8 is an XRD Graph for a Type 2.C Catalyst

FIG. 9 is an XRD Graph for a Type 2.D Catalyst

FIG. 10 is an XRD Comparison Graph for Type 2 Catalysts

FIG. 11 is an XRD Comparison Graph for Cu—Mn Spinels

FIG. 12 is a Series of Conversion Graphs for Type 1 Catalysts

FIG. 13 is a Series of Conversion Graphs for Type 2 Catalysts

FIG. 14 is NO Conversion Comparison Graph for two type of Cu—Mn spinel

### DETAILED DESCRIPTION

Disclosed here are catalyst materials that may be of use in the conversion of exhaust gases, according to an embodiment.

The present disclosure is here described in detail with reference to embodiments illustrated in the drawings, which form a part hereof. In the drawings, which are not necessarily to scale or to proportion, similar symbols typically identify similar components, unless context dictates otherwise. Other embodiments may be used and/or other changes may be made without departing from the spirit or scope of the present disclosure. The illustrative embodiments described in the detailed description are not meant to be limiting of the subject matter presented herein.

### DEFINITIONS

As used here, the following terms have the following definitions:

“Exhaust” refers to the discharge of gases, vapor, and fumes that may include hydrocarbons, nitrogen oxide, and/or carbon monoxide.

“R Value” refers to the number obtained by dividing the reducing potential by the oxidizing potential.

“Rich Exhaust” refers to exhaust with an R value above 1.

“Lean Exhaust” refers to exhaust with an R value below 1.

“Conversion” refers to the chemical alteration of at least one material into one or more other materials.

“Catalyst” refers to one or more materials that may be of use in the conversion of one or more other materials.

“Carrier Material Oxide (CMO)” refers to support materials used for providing a surface for at least one catalyst.

“Oxygen Storage Material (OSM)” refers to a material able to take up oxygen from oxygen rich streams and able to release oxygen to oxygen deficient streams.

“Three Way Catalyst (TWC)” refers to a catalyst suitable for use in converting at least hydrocarbons, nitrogen oxide, and carbon monoxide.

“Oxidation Catalyst” refers to a catalyst suitable for use in converting at least hydrocarbons and carbon monoxide.

“Wash-coat” refers to at least one coating including at least one oxide solid that may be deposited on a substrate.

“Over-coat” refers to at least one coating that may be deposited on at least one wash-coat or impregnation layer.

“Zero Platinum Group (ZPGM) Catalyst” refers to a catalyst completely or substantially free of platinum group metals.

“Platinum Group Metals (PGMs)” refers to platinum, palladium, ruthenium, iridium, osmium, and rhodium.

### DESCRIPTION

A catalyst in conjunction with a sufficiently lean exhaust (containing excess oxygen) may result in the oxidation of residual HC and CO to small amounts of carbon dioxide (CO2) and water (H2O), where equations (1) and (2) take place.

2CO+O₂→2CO2 (1)

2CₙHₙ+(2m+½n)O₂→2mCO₂+nH2O (2)

Although dissociation of NO into its elements may be thermodynamically favored, under practical lean conditions this may not occur. Active surfaces for NO dissociation include metallic surfaces, and dissociative adsorption of NO, equation (3), may be followed by a rapid desorption of N2, equation (4). However, oxygen atoms may remain strongly adsorbed on the catalyst surface, and soon coverage by oxygen may be complete, which may prevent further adsorption of NO, thus halting its dissociation. Effectively, the oxygen atoms under the prevailing conditions may be removed through a reaction with a reductant, for example with hydrogen, as illustrated in equation (5), or with CO as in equation (6), to provide an active surface for further NO dissociation.

2NO 2N_{ads}+2Oads (3)

N_{ads}+N_{ads}→N2 (4)

Oads+H₂→H2O (5)

Oads+CO→CO2 (6)

Materials that may allow one or more of these conversions to take place may include ZPGM catalysts, including catalysts containing Copper (Cu), Manganese (Mn) and combinations thereof. Catalysts containing the aforementioned metals may include any suitable Carrier Material Oxides, including Cerium Oxides, Aluminum Oxides, Titanium Oxides, doped aluminum oxide, doped ceria, fluorite, zirconium oxide, doped zirconia, titanium oxide, tin oxide, silicon dioxide, zeolite, and combinations thereof. ZPGM Catalyst may include any number of suitable OSMs, including cerium oxide, zirconium oxide, lanthanum oxide, yttrium oxide, lanthanide oxides, actinide oxides, and combinations thereof. Catalysts containing the aforementioned metals, Carrier Material Oxides, and/or Oxygen Storage Materials may be suitable for use in conjunction with catalysts containing PGMs. Catalysts with the aforementioned qualities may be used in a washcoat or overcoat, in ways similar to those described in US 20100240525.

Catalyst Preparation

Catalysts similar to those described above may be prepared by co-precipitation method. Co-precipitation may include the preparation of one or more suitable metal salt solutions, where precipitate may be formed by the addition of one or more of NaOH solution, Na2CO3 solution, ammonium hydroxide (NH4OH) solution as precipitant agent.

This precipitate may be formed over a slurry including at least one suitable carrier material oxide, where the slurry may include any number of additional suitable Carrier Material Oxides, and may include one or more suitable Oxygen Storage Materials. The slurry may then undergo filtering and may undergo washing, where the resulting material may be dried and may later be calcined.

Metal salt solutions suitable for use in the co-precipitation process described above may include solutions of Copper Nitrate (CuNO₃) or Copper acetate and Manganese Nitrate (MnNO₃) or Manganese acetate in any suitable solvent.

Other methods suitable for preparing catalysts similar to those described above may include sol-gel methods and templating methods, including polymeric templating agent such as polyethylene glycol, polyvinyl alcohol, poly(N-vinyl-2pyrrolidone) (PVP), polyacrylonitrile, polyacrylic acid, multilayer polyelectrolyte films, poly-siloxane, oligosaccharides, poly(4-vinylpyridine), poly(N,Ndialkylcarbodiimide), chitosan, hyper-branched aromatic polyamides and other suitable polymers.

The catalyst may also be formed on a substrate, where the substrate may be of any suitable material, including cordierite. The washcoat may include one or more carrier material oxides and may also include one or more OSMs. Cu, Mn, and combinations thereof may be precipitated on said one or more carrier material oxides or combination of carrier material oxide and oxygen storage material, where the catalyst may be synthesized by any suitable chemical technique, including solid-state synthesis and co-precipitation. The milled catalyst and carrier material oxide may then be deposited on a substrate, forming a washcoat, where the washcoat may undergo one or more heat treatments.

XRD Analysis

Catalysts containing Cu and Mn include: Type 1 Catalysts, prepared so as to have a Cu/(Cu+Mn) molar ratio of about 0.50; and Type 2 Catalysts, prepared so as to have a Cu/(Cu+Mn) molar ratio of about 0.33.

Type 1 Catalysts may be calcined at any suitable temperature, including temperatures in the range of 100-700° C.

In this disclosure, Type 1 Catalysts calcined at the following temperatures are referred to as follows:

Type 1.A Catalysts refer to catalysts calcined at about 100° C.

Type 1.B Catalysts refer to catalysts calcined at about 300° C.

Type 1.C Catalysts refer to catalysts calcined at about 500° C.

Type 1.D Catalysts refer to catalysts calcined at about 700° C.

In this disclosure, Type 2 Catalysts calcined at the following temperatures are referred to as follows:

Type 2.A Catalysts refer to catalysts calcined at about 100° C.

Type 2.B Catalysts refer to catalysts calcined at about 300° C.

Type 2.C Catalysts refer to catalysts calcined at about 600° C.

Type 2.D Catalysts refer to catalysts calcined at about 800° C.

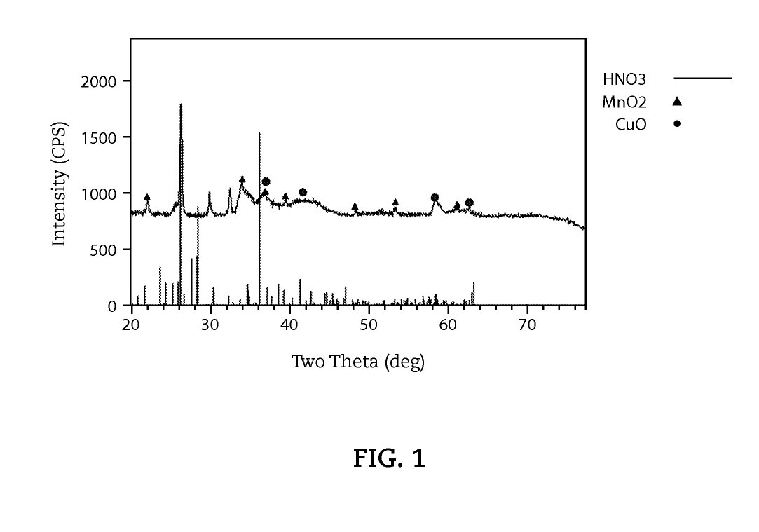

FIG. 1 shows XRD Graph 100 for Type 1.A Catalyst 102. XRD Graph 100 shows the presence of HNO3 104, MnO2 106, and CuO 108. HNO3 104 may be present when Nitrate is used in the synthesizing of Type 1.A Catalyst 102 and the calcining temperature may be insufficient to burn HNO3 104. The evidence of the formation of a Cu—Mn spinel phase may not be observed. However, a mixed phase of Cu (II) and Mn (IV) oxides may form. An average crystallite size of this mixed phase may be calculated from X-Ray diffraction peaks by using the Scherrer equation, and may have a value of about 3 nm.

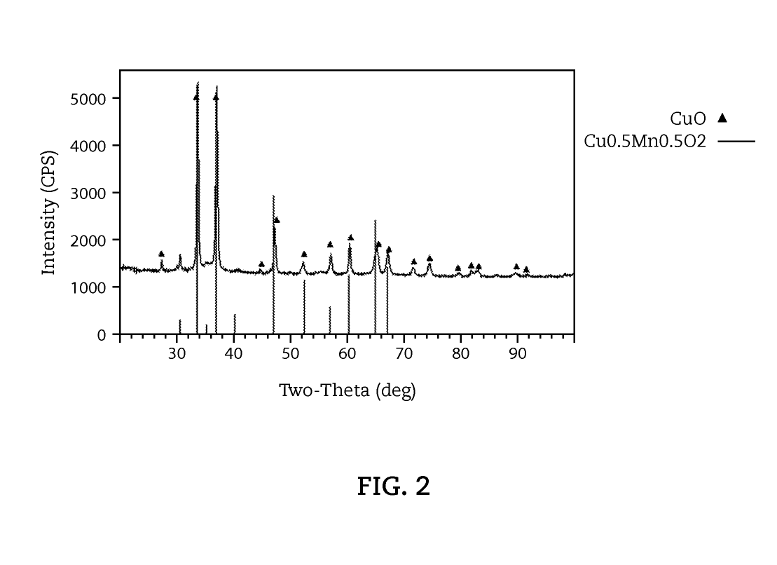

FIG. 2 shows XRD Graph 200 for Type 1.B Catalyst 202. XRD Graph 200 shows CuO 108 and Cu—Mn Solid Solution 204, where Cu—Mn Solid Solution 204 has the chemical formula Cu_{0.5}Mn_{0.5}O₂. The evidence of a formation of a Cu—Mn spinel phase may not be observed. An average crystallite size of this mixed phase, calculated from X-Ray diffraction peaks by using Scherrer equation, may be about 16 nm.

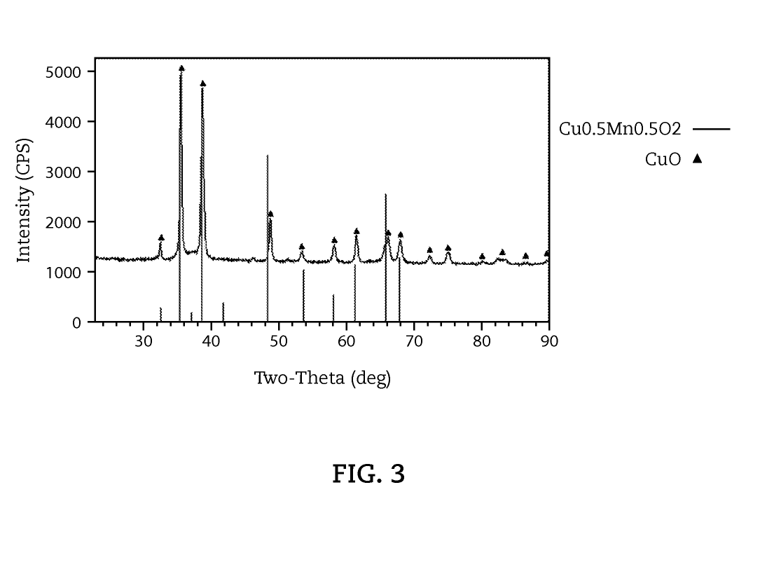

FIG. 3 shows XRD Graph 300 for Type 1.C Catalyst 302. XRD Graph 200 shows CuO 108 and Cu—Mn Solid Solution 304, where Cu—Mn Solid Solution 304 has the chemical formula Cu_{0.5}Mn_{0.5}O₂. The evidence of a formation of a Cu—Mn spinel phase may not be observed. An average crystallite size of this mixed phase, calculated from X-Ray diffraction peaks by using Scherrer equation, may be about 14 nm.

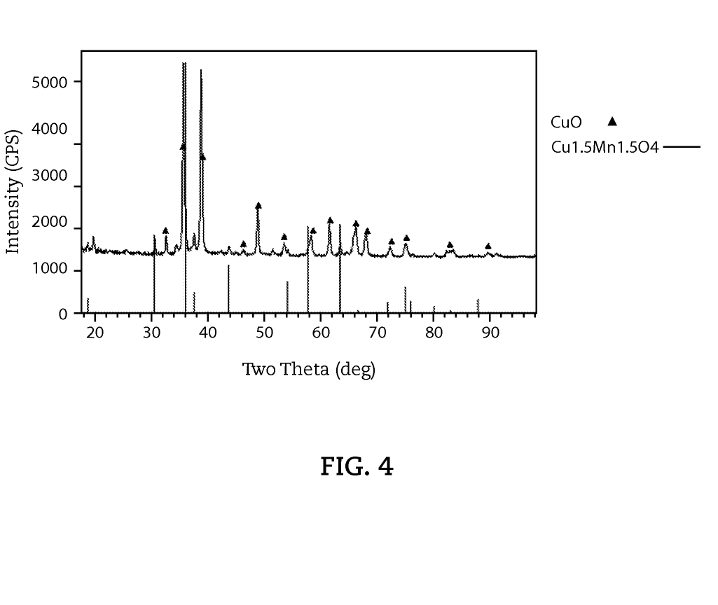

FIG. 4 shows XRD Graph 400 for Type 1.D Catalyst 402. XRD Graph 400 shows CuO 108 and Non-Stoichiometric Cu—Mn Spinel 404, where Non-Stoichiometric Cu—Mn Spinel 404 has the chemical formula Cu_{1.5}Mn_{1.5}O₄. An average crystallite size of this mixed phase, calculated from X-Ray diffraction peaks by using Scherrer equation, may be about 16 nm.

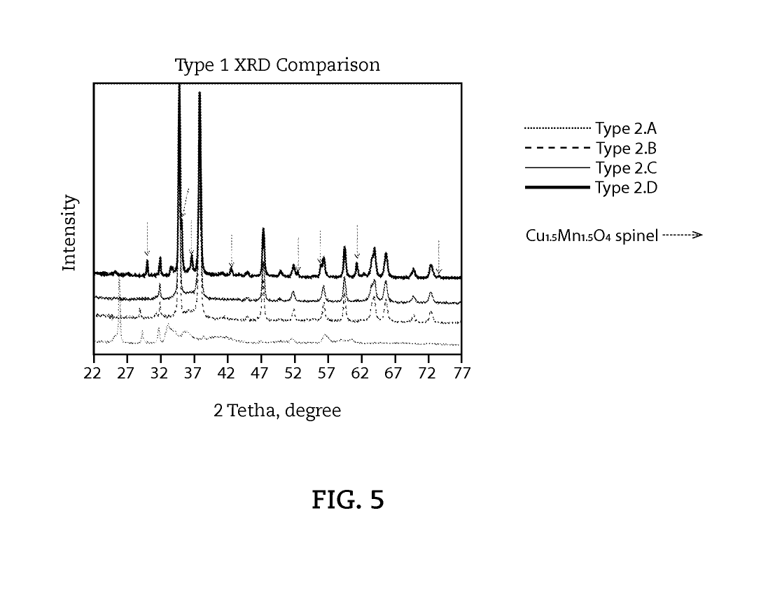

FIG. 5 shows XRD Comparison Graph 500, comparing Type 1.A Catalyst 102, Type 1.B Catalyst 202, Type 1.C Catalyst 302, and Type 1.D Catalyst 402. XRD Comparison Graph 500 details peaks for Non-Stoichiometric Cu—Mn Spinel 404 in Type 1.D Catalyst 402, while Type 1.A Catalyst 102, Type 1.B Catalyst 202, Type 1.C Catalyst 302 may not exhibit such peaks. The formation of a Cu—Mn spinel phase may be observed when a Type 1 catalyst may be calcined at about 700° C., which may suggest Non-Stoichiometric Cu—Mn Spinel may begin to form at 700° C.

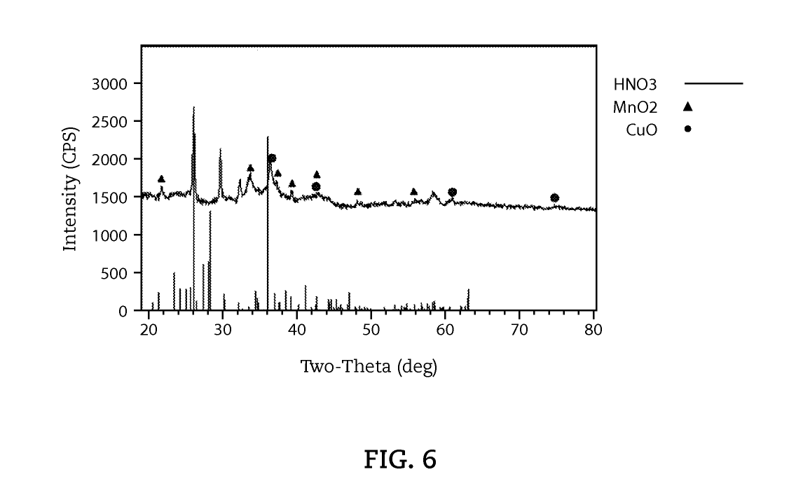

FIG. 6 shows XRD Graph 600 for Type 2.A Catalyst 602. XRD Graph 600 shows the presence of HNO3 104, MnO2 106, and Cu2O 604. HNO3 104 may be present when Nitrate is used in the synthesizing of Type 2.A Catalyst 602 and the calcining temperature may be insufficient to burn HNO3 104. The evidence of the formation of a Cu—Mn spinel phase may not be observed. Only a mixed phase of Cu (I) and Mn (IV) oxides may form. An average crystallite size of this mixed phase may be calculated from X-Ray diffraction peaks by using the Scherrer equation, and may have a value of about 11 nm.

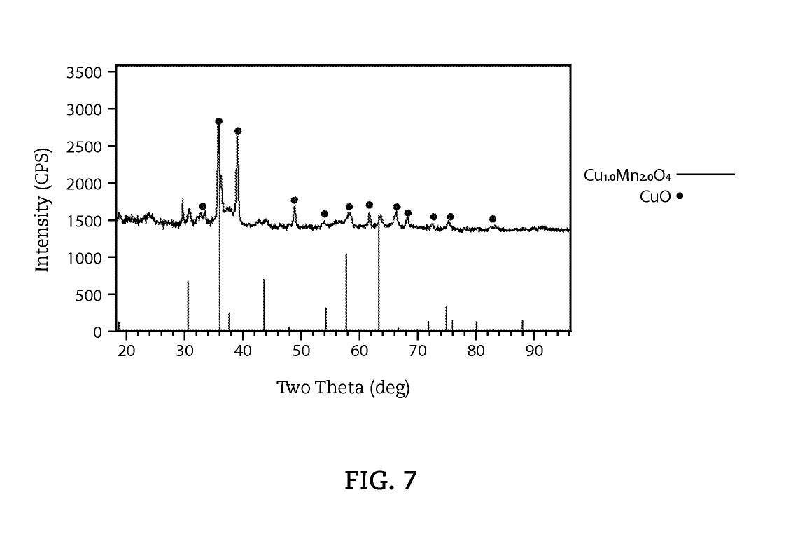

FIG. 7 shows XRD Graph 700 for Type 2.B Catalyst 702. XRD Graph 700 shows CuO 108, and Stoichiometric Cu—Mn Spinel 704, where Stoichiometric Cu—Mn Spinel 704 has the chemical formula Cu₁Mn₂O₄. It may be observed that a Stoichiometric Cu—Mn spinel phase may begin to form at about 300° C. An average crystallite size of this mixed phase, calculated from X-Ray diffraction peaks by using Scherrer equation, may be about 10 nm.

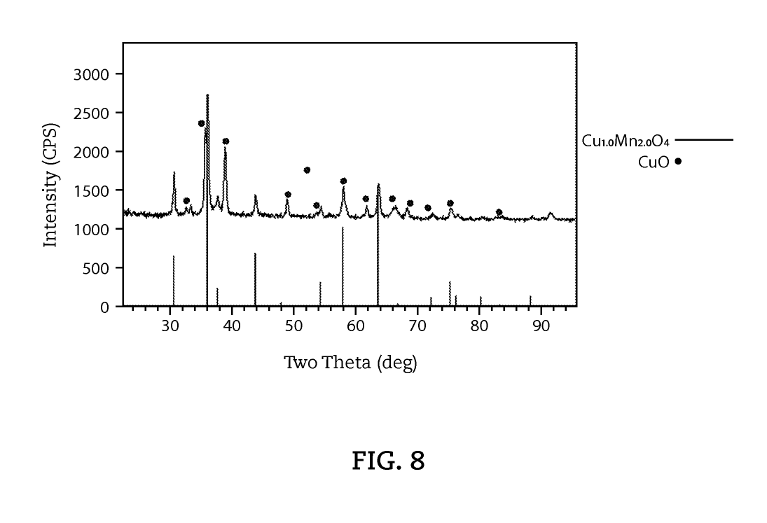

FIG. 8 shows XRD Graph 800 for Type 2.0 Catalyst 802. XRD Graph 800 shows CuO 108 and Stoichiometric Cu—Mn Spinel 804, where Stoichiometric Cu—Mn Spinel 704 has the chemical formula Cu₁Mn₂O₄. An average crystallite size of this mixed phase, calculated from X-Ray diffraction peaks by using Scherrer equation, may be about 13 nm.

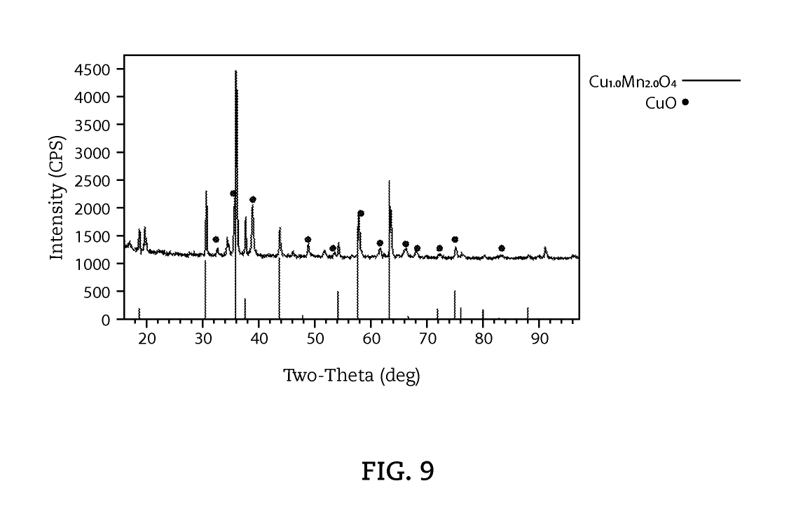

FIG. 9 shows XRD Graph 900 for Type 2.D Catalyst 902. XRD Graph 900 shows CuO 108 and Stoichiometric Cu—Mn Spinel 904, where Stoichiometric Cu—Mn Spinel 704 has the chemical formula Cu₁Mn₂O₄. An average crystallite size of this mixed phase, calculated from X-Ray diffraction peaks by using Scherrer equation, may be about 5 nm.

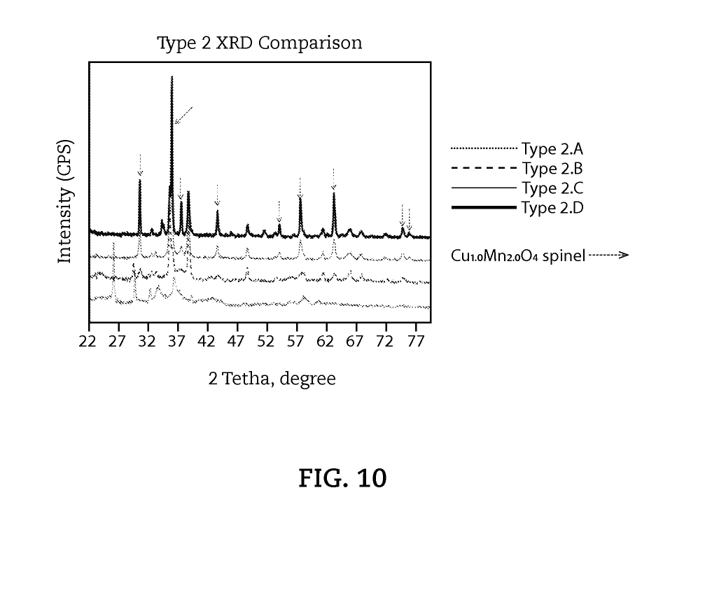

FIG. 10 shows XRD Comparison Graph 1000, comparing Type 2.A Catalyst 602, Type 2.B Catalyst 702, Type 2.C Catalyst 802, and Type 2.D Catalyst 902. XRD Comparison Graph 1000 details peaks for Stoichiometric Cu—Mn Spinel 704 in Type 2.B Catalyst 702, Type 2.C Catalyst 802, and Type 2.D Catalyst 902. Stoichiometric Cu—Mn Spinel 704 may form when calcining at temperatures greater or equal to 300° C., while Type 2.A Catalyst 602 may not form Stoichiometric Cu—Mn Spinel 704 due to its calcining at 100° C.

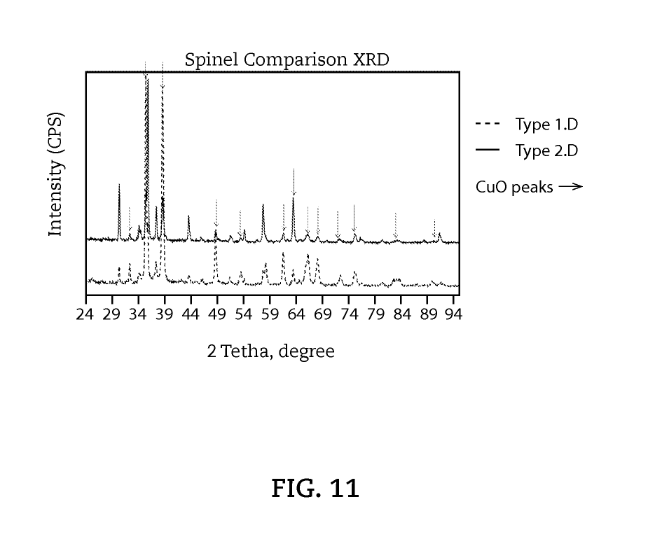

FIG. 11 shows XRD Comparison Graph 1100, comparing Type 1.D Catalyst 402 and Type 2.D Catalyst 902. XRD Comparison Graph 1100 shows CuO Peaks 1102 which shows with arrow for Type 1.D Catalyst 402 and Type 2.D Catalyst 902. Other diffraction peaks may correspond to Cu—Mn spinel, which may exist in both samples. Type 1.D Catalyst 402 may show higher intensity CuO Peaks 1102 with lower FWHM when compared to Type 2.D Catalyst 902, which may result in a larger crystallite size of CuO. The larger crystallite size of Type 1.D Catalyst 402 when compared to Type 2.D Catalyst 902 may correspond to larger CuO crystallite size exist in both samples.

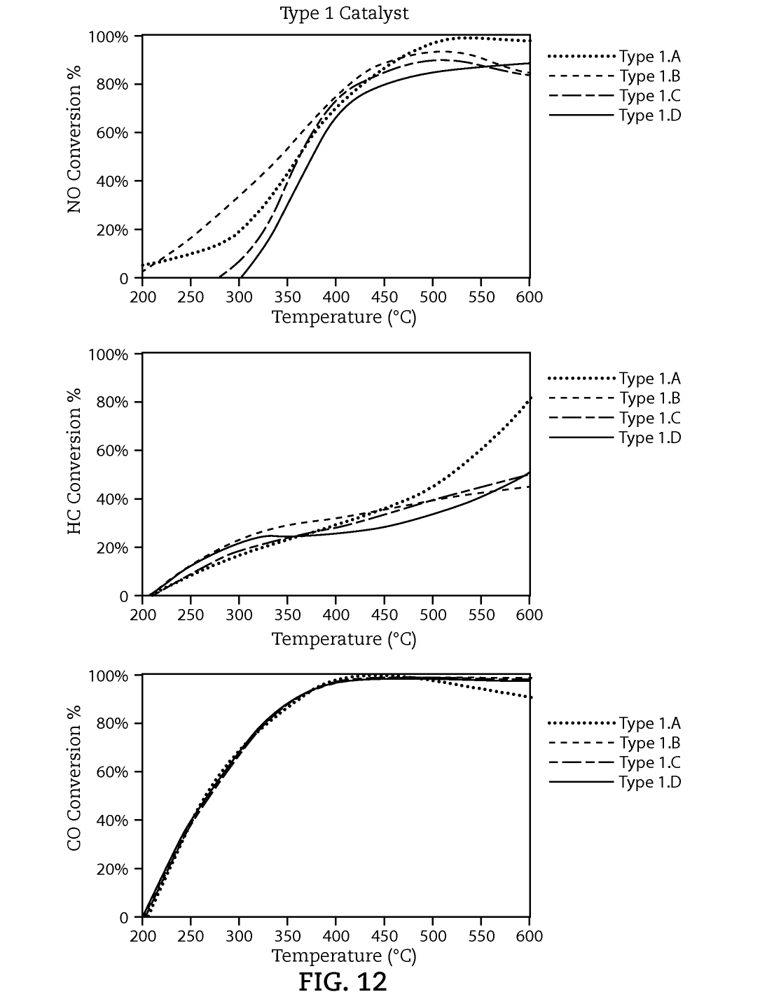

FIG. 12 shows Type 1 Catalyst Conversion Graphs 1200, including NO Conversion Graph 1202, HC Conversion Graph 1204, and CO Conversion Graph 1206 for Type 1.A Catalyst 102, Type 1.B Catalyst 202, Type 1.C Catalyst 302, and Type 1.D Catalyst 402 in a rich exhaust condition with a R-value=1.224 in a temperature range of about 200° C. to 600° C.

NO Conversion Graph 1202 shows Type 1.C Catalyst 302 may have a higher conversion rate when compared to Type 1.A Catalyst 102, Type 1.B Catalyst 202, and Type 1.D Catalyst 402 at temperatures below about 390° C. Type 1.D Catalyst 402 may have a generally lower NO conversion rate in NO Conversion Graph 1202 when compared to Type 1.A Catalyst 102, Type 1.B Catalyst 202, Type 1.C Catalyst 302 in the temperature range tested. This may suggest non-Stoichiometric Cu—Mn Spinel may have a lower NOx conversion rate compared to a mixed oxide phase of copper and manganese.

HC Conversion Graph 1204 shows Type 1.C Catalyst 302 may have a higher conversion rate when compared to Type 1.A Catalyst 102, Type 1.B Catalyst 202, and Type 1.D Catalyst 402 at temperatures below about 440° C. HC Conversion Graph 1204 also shows Type 1.A Catalyst 102 may have a higher conversion rate when compared to Type 1.B Catalyst 202, Type 1.C Catalyst 302, and Type 1.D Catalyst 402 at temperatures above about 440° C. in the temperature range tested, while Type 1.D Catalyst 402 seems to have a generally lower conversion rate at higher range of temperatures when compared to Type 1.A Catalyst 102, Type 1.B Catalyst 202, Type 1.C Catalyst 302.

CO Conversion Graph 1206 shows Type 1.A Catalyst 102, Type 1.B Catalyst 202, Type 1.C Catalyst 302, and Type 1.D Catalyst 402 may have very similar CO conversion rates throughout the temperature range tested.

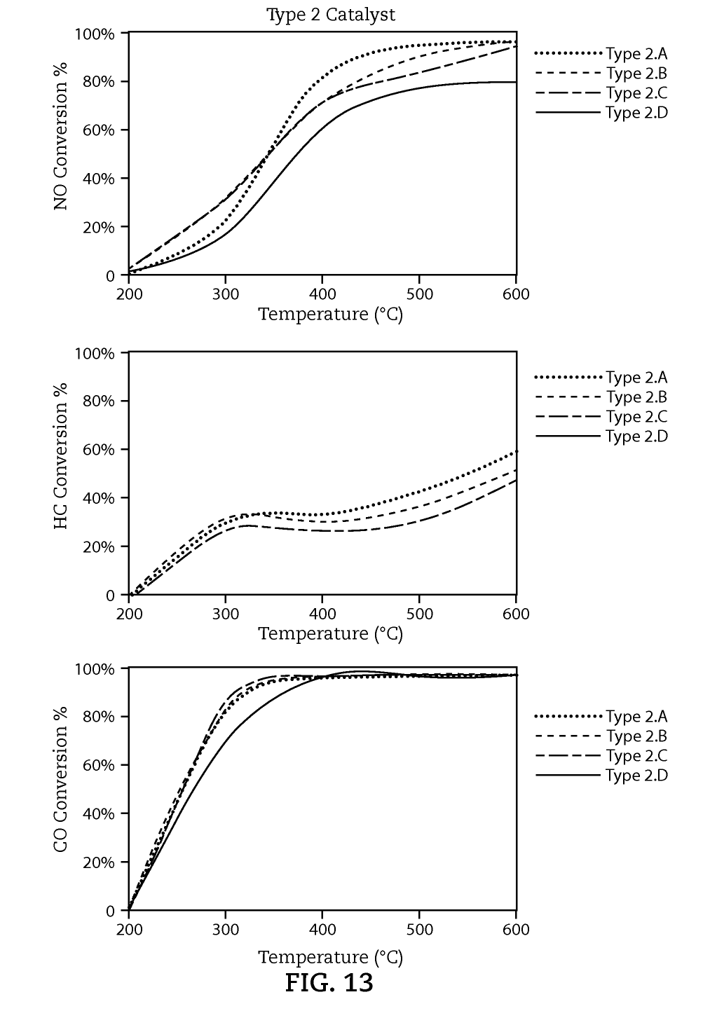

FIG. 13 shows Type 2 Catalyst Conversion Graphs 1300, including NO Conversion Graph 1302, HC Conversion Graph 1304, and CO Conversion Graph 1306 for Type 2.A Catalyst 602, Type 2.B Catalyst 702, Type 2.0 Catalyst 802, and Type 2.D Catalyst 902 in a rich exhaust condition with a R-value=1.224 in a temperature range of about 200° C. to 600° C.

NO Conversion Graph 1302 shows Type 2.B Catalyst 702 and Type 2.0 Catalyst 802 may have very similar conversion rates at temperatures below 400° C., and may have higher conversion rates compared to Type 2.A Catalyst 602 and Type 2.D Catalyst 902 in the temperature range of about 200° C. to 400° C. Type 2.B Catalyst 702 and Type 2.0 Catalyst 802 may have a similar Stoichiometric Cu—Mn Spinel having approximatly the same crystallite size. NO Conversion Graph 1302 shows Type 2.A Catalyst 602 may have a higher NO conversion rate when compared to Type 2.B Catalyst 702, Type 2.0 Catalyst 802, and Type 2.D Catalyst 902 at temperatures above about 350° C. within the temperature range tested. NO Conversion Graph 1302 shows Type 2.D Catalyst 902 may have a generally lower NO conversion rate when compared to Type 2.A Catalyst 602, Type 2.B Catalyst 702, and Type 2.0 Catalyst 802 throughout the temperature range tested.

HC Conversion Graph 1304 shows Type 2.A Catalyst 602 may have a higher HC conversion rate when compared to Type 2.B Catalyst 702, Type 2.0 Catalyst 802, and Type 2.D Catalyst 902 at temperatures above about 320° C. within the temperature range tested. HC Conversion Graph 1304 shows Type 2.B Catalyst 702 may have a higher HC conversion rate when compared to Type 2.A Catalyst 602, Type 2.0 Catalyst 802, and Type 2.D Catalyst 902 at temperatures below about 320° C. within the temperature range tested. HC Conversion Graph 1304 shows Type 2.D Catalyst 902 may have a lower HC conversion rate when compared to Type 2.A Catalyst 602, Type 2.B Catalyst 702, and Type 2.0 Catalyst 802 within the temperature range tested.

CO Conversion Graph 1306 shows Type 2.D Catalyst 902 may have a lower CO conversion rate when compared to Type 2.A Catalyst 602, Type 2.B Catalyst 702, and Type 2.0 Catalyst 802 at temperatures below 400° C. within the temperature range tested. CO Conversion Graph 1306 shows Type 2.A Catalyst 602, Type 2.B Catalyst 702, Type 2.0 Catalyst 802, and Type 2.D Catalyst 902 may have very similar CO conversion rates at temperatures above 400° C. within the temperature range tested.

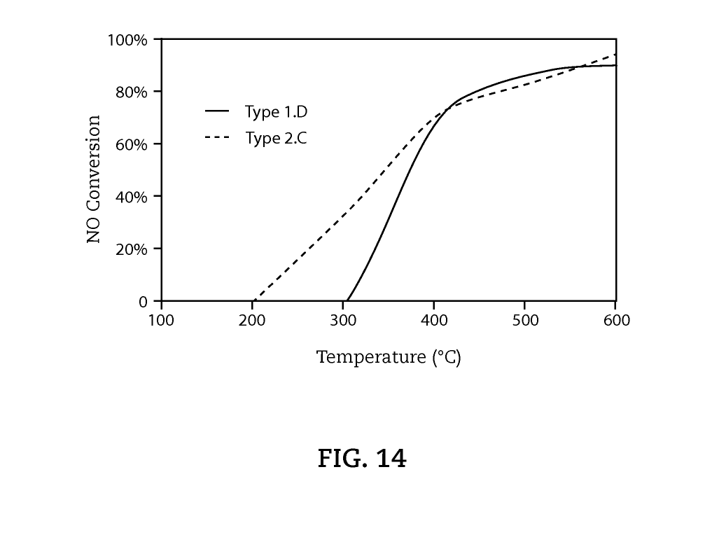

FIG. 14 shows the effect of spinel type on NO Conversion Graph 1400 comparing Type 1.D Catalyst 402 and Type 2.0 Catalyst 802 under rich exhust condition with R-value=1.224 at a temperature range between 200° C. and 600° C. NO Conversion Graph 1400 shows Type 2.0 Catalyst 802 may have higher NO conversion rates compared to Type 1.D Catalyst 402 in the temperature range tested. The difference may be more significant at temperatures lower than 400° C. FIG. 14 may suggest Stoichiometric Cu—Mn Spinels with a general formula of Cu₁Mn₂O₄ may show a higher NO conversion ability compared to non-Stoichiometric Cu—Mn Spinels with a general formula of Cu_{1.5}Mn_{1.5}O₄.

### EXAMPLES

### Example 1

A Type 1 Catalyst is a bulk powder of Cu—Mn that may be prepared from a Copper Nitrate Solution and a Manganese Nitrate Solution. The Mn Nitrate solution may be added to the Cu Nitrate solution in a quantity such that the Cu/(Cu—Mn) molar ratio may be about 0.5, and the solution may be mixed for at least 3 to 4 hours.

Suitable Cu loading may include loadings of about 1 to 50 percent by weight, preferably about 10 to 40 percent by weight. Suitable Mn loadings may include loadings of about 1 to 50 percent by weight, preferably about 10 to 40 percent by weight.

A 1 molar Sodium Hydroxide solution may then added to the Cu—Mn Nitrate Solution as precipitant agent. Suitable pH values for the precipitation solution may include pH values of about 8 to 9.5. The precipitation solution may then be aged under suitable stirring conditions, including continuous stirring at room temperature for any suitable period of time. Suitable periods of time may include times in a range 12 hours to 36 hours, preferably 20 hours.

During aging, the pH of the solution may be kept at a suitable value between neutral and basic conditions, preferably values in a range between 7.5 to 8.5. This may be done by adding a diluted ammonium hydroxide (NH4OH) solution. The resulting precipitate may then be filtered and washed a suitable number of times, and may afterwards be dried at 120° C. over night. The resulting bulk powder catalyst may then be calcined at any suitable temperature, including 100° C., 300° C., 500° C. and 700° C., and may behave similarly to Type 1.A Catalyst 102, Type 1.B Catalyst 202, Type 1.C Catalyst 302, and Type 1.D Catalyst 402, respectively.

### Example 2

A Type 2 Catalyst is a bulk powder of Cu—Mn that may be prepared from a Copper Nitrate Solution and a Manganese Nitrate Solution. The Mn Nitrate solution may be added to the Cu Nitrate solution in a quantity such that the Cu/(Cu—Mn) molar ratio may be about 0.33, and the solution may be mixed for at least 3 to 4 hours.

Suitable Cu loadings may include loadings of about 1 to 40 percent by weight, preferably about 10 to 30 percent by weight. Suitable Mn loadings may include loadings of 1 to 60 percent by weight, preferably about 20 to 50 percent by weight.

A 1 molar Sodium Hydroxide solution may then added to the Cu—Mn Nitrate Solution as precipitant agent. Suitable pH values for the precipitation solution may include pH values of about 8 to 9.5. The precipitation solution may then be aged under suitable stirring conditions, including continuous stirring at room temperature for any suitable period of time. Suitable periods of time may include times in a range 12 hours to 24 hours, preferably 20 hours.

During aging, the pH of the solution may be kept at a suitable value between neutral and basic conditions, preferably values in a range between 7.5 to 8.5. This may be done by adding a diluted ammonium hydroxide (NH4OH) solution. The resulting precipitate may then be filtered and washed a suitable number of times, and may afterwards be dried at 120° C. over night. The resulting bulk powder catalyst may then be calcined at any suitable temperature, including 100° C., 300° C., 600° C. and 800° C., and may behave similarly to Type 2.A Catalyst 602, Type 2.B Catalyst 702, Type 2.0 Catalyst 802, and Type 2.D Catalyst 902, respectively.

### Example 3

A Type 1 or Type 2 of Cu—Mn catalyst similar to those described in Example 1 and Example 2 may be of use in a washcoat of a catalyst substrate, where the catalyst may be prepared from a Copper Nitrate Solution and a Manganese Nitrate Solution. The Mn Nitrate solution may be added to the Cu Nitrate solution in a quantity such that the Cu/(Cu—Mn) molar ratio may be about 0.5 or 0.33, and the solution may be mixed for at least 3 to 4 hours. The Cu—Mn solution then may precipitate on a previously milled carrier metal oxide by any suitable precipitant agent. Carrier metal oxide may include Cerium Oxide, Alumina, Lanthanum doped alumina, Titanium Oxide, Zirconia, Ceria-Zirconia, Nb2O5-ZrO2 and any combination thereof. The carrier metal oxide may also milled in present of Oxygen Storage Materials, such as Cerium Oxide, Lanthanum oxide, Yttrium oxide, Lanthanide Oxides, Actinide Oxides, and any combination thereof.

A washcoat may be prepared by methods well known in the art. Washcoat may comprise any of the Cu—Mn mixed phases and additional components described above. Washcoat may be deposited on a substrate and subsequently treated. The treating may be done at a temperature between 300° C. and 800° C. depends on type of Cu—Mn mixed oxide phase. The treatment may last from about 2 to about 6 hours.

### Example 4

A Cu—Mn catalyst similar to those described in Examples 1 and 2 may be of use in an overcoat of a catalyst substrate having at least one washcoat, where the catalyst in overcoat may be prepared from a Copper Nitrate Solution and a Manganese Nitrate Solution. The Mn Nitrate solution may be added to the Cu Nitrate solution in a quantity such that the Cu/(Cu—Mn) molar ratio may be about 0.33 or may be about 0.5, and the solution may be mixed for at least 3 to 4 hours. The Cu—Mn solution then may precipitate on a previously milled carrier metal oxide by any suitable precipitant agent. Carrier metal oxide may include Cerium Oxide, Alumina, Lanthanum doped alumina, Titanium Oxide, Zirconia, Ceria-Zirconia, Nb2O5-ZrO2, and any combination thereof. The carrier metal oxide may also milled in present of Oxygen Storage Materials, such as Cerium Oxide, Lanthanum oxide, Yttrium oxide, Lanthanide Oxides, Actinide Oxides, and any combination thereof.

An overcoat may be prepared by methods well known in the art. Overcoat may comprise any of the Cu—Mn mixed phases and additional components described above. Overcoat may be deposited on a previously washcoated substrate and subsequently treated. The treating may be done at a temperature between 300° C. and 800° C. depends on type of Cu—Mn mixed oxide phase. The treatment may last from about 2 to about 6 hours.

I claim:

1. A catalyst system, comprising:
a substrate;
a washcoat suitable for deposition on the substrate, comprising at least one oxide solid selected from the group consisting of at least one of a carrier metal oxide, and a catalyst; and
an overcoat suitable for deposition on the substrate, comprising at least one overcoat oxide solid selected from the group consisting of at least one of a carrier metal oxide, and a catalyst;
wherein at least one of the catalysts comprises at least one spinel structured compound having the formula AB₂O₄, wherein each of A and B is selected from the group consisting of at least one of copper and manganese and wherein a portion of the at least one spinel structured compound is stoichiometric; and
wherein the at least one spinel structured compound is formed by calcination at a temperature in a range of about 300° C. to about 800° C.

2. The catalyst system of claim 1, wherein a portion of the at least one spinel structured compound is non-stoichiometric.

3. The catalyst system of claim 2, wherein the at least one spinel structured compound is in mixed phase with copper oxide or manganese oxide.

4. The catalyst system of claim 3, wherein the mixed phase has a Cu/(Cu—Mn) molar ratio of about 0.50.

5. The catalyst system of claim 3, wherein the mixed phase has a Cu/(Cu—Mn) molar ratio of about 0.33.

6. The catalyst system of claim 1, wherein the non-stoichiometric portion of the at least one spinel structured compound is formed by calcination at about 700° C.

7. The catalyst system of claim 1, wherein the at least one spinel structured compound is formed by calcination at a temperature in a range of about 300° C. to about 600° C.

8. The catalyst of claim 1, wherein the at least one carrier metal oxide is selected from the group consisting of cerium oxide, alumina, lanthanum doped alumina, titanium oxide, zirconia, ceria-zirconia, Nb₂O₅—ZrO₂, and combinations thereof.

9. The catalyst system of claim 1, wherein the washcoat further comprises at least one oxygen storage material selected from the group consisting of cerium oxide, zirconium oxide, lanthanum oxide, yttrium oxide, lanthanide oxides, actinide oxides, and combinations thereof.

10. The catalyst system of claim 1, wherein the overcoat further comprises at least one oxygen storage material selected from the group consisting of cerium oxide, zirconium oxide, lanthanum oxide, yttrium oxide, lanthanide oxides, actinide oxides, and combinations thereof.

11. The catalyst system of claim 1, wherein the catalyst is prepared by a method selected from the group consisting of co-milling, co-precipitation, impregnation, stabilization, templating, and the sol-gel method.

12. The catalyst system of claim 11, wherein the method uses at least one material selected from the group consisting of copper nitrate, copper acetate, manganese nitrate, manganese acetate, and combinations thereof.

13. The catalyst system of claim 11, wherein a co-precipitant agent is selected from the group consisting of an NaOH solution, an Na₂CO₃ solution, and an NH4OH solution and is aged from about 12 hours to about 36 hours.

14. The catalyst system of claim 1, wherein a T50 conversion temperature for the hydrocarbons is less than 500 degrees Celsius.

15. The catalyst system of claim 1, wherein a T50 conversion temperature for nitrogen oxide is about 350 degrees Celsius.

16. The catalyst system of claim 1, wherein a T50 conversion temperature for the carbon monoxide is less than about 300 degrees Celsius.

17. The catalyst system of claim 1, wherein the stoichiometric portion of the at least one spinel structured compound has a greater NO conversion rate compared to the non-stoichiometric portion of the at least one spinel structured compound under exhaust rich condition.
